(19) United States
(12) Patent Application Publication
(10) Pub. No.: US 2015/0005927 A1
(43) Pub. Date: Jan. 1, 2015

(54) FLEXIBLE, SCALABLE FREIGHT LOADING SYSTEM

(71) Applicant: Cassidian Airborne Solutions GmbH, Bremen (DE)

(72) Inventors: Stefan Makrinus, Bremen (DE); Alf Paulsen, Oldenburg (DE); Ekkehard Zischow, Stuhr (DE)

(21) Appl. No.: 14/375,187

(22) PCT Filed: Feb. 8, 2013
(86) PCT No.: PCT/EP2013/052529

§ 371 Date: Jul. 29, 2014

(30) Foreign Application Priority Data
Feb. 10, 2012 (DE) 10 2012 002 485.1

(51) Int. Cl. G05B 19/02; B64D 9/00; B60P 7/13

(52) U.S. Cl. CPC G05B 19/02; B60P 7/13; B64D 9/00; G05B 2219/2621; G05B 2219/25032
USPC 700/228

(57) ABSTRACT

The invention relates to a scalable freight loading system, in particular for an aircraft, comprising driving and securing means or freight packages, which are controlled by it central control device (DCB), wherein the loading surface is split into sectors, a local control (SCB 1-x) being assigned to each sector, and the conveying and securing elements (PDC) of a sector are connected to the central control device (DCB) via a bus system (CAN bus). According to the invention, the bus system itself or an electronic component connected to the bus system, particularly the central control device (DGB) or the local control anon (SCB 1-x) assigned to each sector, are provided with an interface via which the control software stored in a storage unit of the central control device (DCB), in a local control unit (CCB, SCB 1-x) or further electronic components connected to the bus system, such as further functionally supplemental controllers, can be made accessible and modified.

A scalable freight loading system, in particular for an aircraft, as well as a method for operating such a scalable freight system is known from the DE 10 2005 040 408 A1, wherein the freight loading system comprises driving means, overlay sensors, latches, proximity switches, human-to-machine interfaces and a central control device, wherein the loading surface is divided into sectors, wherein a local control unit is assigned to each sector, wherein the conveying means, overlay sensors, and proximity switches of a sector are connected to input/output interfaces of the local control unit and the local control units are connected via a bus system to the central control device.

With this known, scalable freight loading system upon which the invention is based, a software program for controlling the operation of the freight loading system is stored in the central control device and insofar as necessary also in the local control units. The software stored in the known, existing freight loading systems is static, meaning it is fixedly assigned to an individual freight loading system with its components, based on the given conditions for the vehicle or the platform in which the freight loading system is installed. As a result, the control commands stored in the software cannot be changed since they are stored permanently. A change not only means that the new software with its control commands must be loaded at great expense into the control units, but also that the software must be adapted which, above all, results in the disadvantage of requiring a modification of the equipment certification. That is to say, it requires permission from the producer or operator of the vehicle and/or the platform. In turn, this has the disadvantage of requiring a change in the respective components, adaptations to the hardware of the freight loading system including its software and their joint certification in the event that functional incompatibilities or errors occur during the operation of the vehicle or if desired modifications are realized.

The static condition of the software in existing freight loading systems therefore results in inflexibility during the operation of the freight loading system. If the flexibility is to be increased, a change in the software and therewith connected hardware and/or the software-based devices leads to an increase in costs with respect to the aspects of certification and logistics.

It is therefore the object of the invention to create a scalable freight loading system for vehicles, in particular for aircrafts, which system increases the flexibility without additional increases in costs.

According to the invention, the bus system itself or an electronic component that is connected to the bus system, in particular the central control device (DCB) or the local control unit (SCB 1-x) assigned to each sector, is therefore provided with an interface by means of which the control software stored in a storage unit of the central control device (DCB), in a local control unit (CCB, SCB 1-x), or in additional electronic components connected to the bus system is made accessible and can be changed.

As a result, it is advantageously possible to upload a revised or changed, or also a completely new, control software via an autonomous entity which can be located inside as well as outside of the vehicle, for example a central server, via a connection between said entity and the central control device, respectively the local control units. It means that the problem of the static software can be solved in that the software with its control commands which for the most part defines the functionality is independent of the hardware in the central control device and the local control units of its own participants. It furthermore means that as a result of replacing the software, it is not necessary to replace the central control system or the local control units. That is to say, the storage units with fixedly programmed-in control software become independent and are no longer a part of the device.

The software and its components must consequently be downloaded onto the freight loading system from an aircraft internal IT-entity (e.g. a special aircraft server arranged inside the vehicle) or via a cargo hold specific access point (also arranged within the vehicle) with the aid of an external tool (not belonging to the flight system).

The software to be loaded in this case has several components which meet different requirements:

1.

A data file with application software for the scalable freight loading system which contains the control commands for operating the scalable freight loading system. This functional component is made available centrally.

2.

A file containing configuration data, wherein the data in the configuration file control the physical configuration of the freight loading system to be operated (for example the type and number of components, the assembly states for the components, the arrangement of the components in the cargo hold of the vehicle in the logical context and the like).

3.

A parameter file, wherein the data in the parameter file control the operating parameters of the components of the scalable freight loading system.

The files are uploaded via a loading procedure onto the central control device (the central control system) of the freight loading system. In particular, the files are uploaded according to a loading procedure via ARINC 429, alternatively also via the CAN bus, onto the central control system of the freight loading system.

This central system distributes the application software files or the components, and/or the data of the configuration file, and/or the data of the parameter files via the system inherent data bus, in particular via a CAN bus.

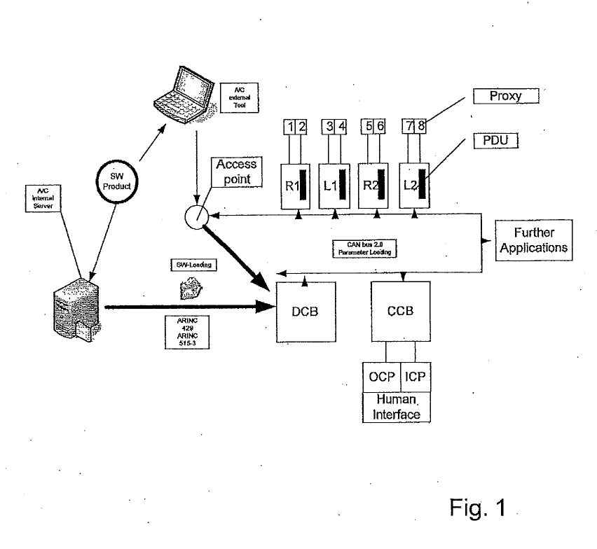

FIG. 1 shows the logical configuration of a freight loading system which can receive changes in the software via a server, in particular the server for the aircraft (LFZ server).

For conveying the freight pieces, several controllable conveying elements, so-called PDU's (power drive units), are arranged in the cargo hold of the aircraft, wherein these elements are preferably arranged in two rows which extend on the right and on the left side of the cargo hold. Securing elements such as latches are furthermore arranged in each row and are monitored with the aid of proximity (proxy) switches.

Furthermore present is a door area control box (DCB) which is used to control the communication with the aircraft and which functions as central control device. A compartment control box CCB serves as control system for energy-technical functions. Different human-to-machine interfaces OCP, ICP can be connected to the CCB. A number of local control units (sector control boxes SCB 1-x) control the elements in the individual sectors of the cargo hold.

The central control unit DCB, the control unit CCB, the local control units SCB and the controllable conveying elements PDU are connected to each other via a bus system, preferably a CAN bus. The central control device and the local control unit assigned to each sector are provided with an interface. The control software, stored in a storage unit of the central control device or the local control unit, can be made accessible and can be changed via the interface.

The LFZ server can be connected via data bus to a specific access point (for this example the door area control box DCB) of the cargo hold and with the aid of ARINC 429 to the freight loading system. The data in this case are loaded onto the central device for the freight loading system in accordance with a standardized loading procedure such as the ARINC 429 or the ARINC 515-3 standard, or also CAN bus specific. The DCB then distributes the application software files, and/or the configuration files, and/or the parameter files via the system-inherent data bus (CAN bus).

As an alternative to the LFZ server, the software changes can also be input into the freight loading system via an access point in the cargo hold, which can be connected via a data bus. The freight loading system is preferably embodied such that a modular software change can be realized, meaning that all software segments can exclusively be changed jointly, or that individual software segments for the application functions and/or the software segment for the configuration of the freight loading system and the arrangement of its components, and/or the software segment for the performance features of the system components can be changed individually.

1. A scalable freight loading system, in particular for an aircraft, comprising means for conveying and securing freight pieces which means are controlled by a central control device (DCB), wherein the loading surface is divided into sectors, a local control unit (SCB 1-x) is assigned to each sector, and the conveying and securing elements (PDU) of a sector are connected via a bus system (CAN bus) to the central control device (DCB), characterized in that the bus system itself or an electronic component that is connected to the bus system, in particular the central control device (DCB) or the local control unit (SCB 1-x) assigned to each sector, are provided with an interface by means of which the control software stored in a storage unit of the central control device (DCB), in a local control unit (CCB, SCB 1-x) or in additional electronic components connected to the bus system, such as functional supplemental controllers, is made accessible and can be changed.

2. The freight loading system according to claim 1, characterized in that it can be connected via a data bus to an external server, in particular the central aircraft server (LFZ server) or a specific access point in the cargo hold.

3. The freight loading system according to claim 1, wherein the software changes are loaded with the aid of a standardized loading procedure, in particular via ARINC 429 or via ARINC 515-3, or also Can bus specific, into the central control device which subsequently distributes these changes via the system-inherent data bus (CAN bus).

4. The freight loading system according to claim 1 wherein the system is embodied such that a modular software change can be realized in that individual software segments of the system can be changed.
